(19) United States
(12) Patent Application Publication
(10) Pub. No.: US 2026/0306351 A1
(43) Pub. Date: Oct. 8, 2026

(54) EXTERNAL COLD-AND-HOT SWITCHING FASCIA GUN

(71) Applicant: Dongguan Shi Fule Technology Limited, Dongguan (CN)

(72) Inventor: QIONGYAO AO, Shenzhen (CN)

(21) Appl. No.: 19/181,996

(22) Filed: Apr. 17, 2025

(30) Foreign Application Priority Data
Apr. 8, 2025 (CN) 202520650406.8

(51) Int. Cl. A61H 23/02

(52) U.S. Cl. CPC A61H 23/02; A61H 2201/0228

(57) ABSTRACT

An external cold-and-hot switching fascia gun is provided, which includes a housing, the housing is provided with a driving device, a first controller, and a control panel provided on a surface of the housing. An output end of the driving device is rotatably connected to a piston component, the piston component is movably connected to the housing. One end of the piston component away from the driving device is detachably connected to a massage component, a second controller is provided in the massage component, the second controller is connected to the cold-and-hot switching device in the massage component. The control panel is electrically connected to the first controller, and the first controller is matched with the second controller to keep the massage component in a working state. The cold-and-hot switching device is operated through the control panel, regardless of a reciprocating speed of the piston component.

### CROSS-REFERENCE TO RELATED APPLICATIONS

This application claims priority to Chinese Patent Application No. 202520650406.8, filed on Apr. 08, 2025, which is hereby incorporated by reference in its entirety.

### TECHNICAL FIELD

The present disclosure relates to the field of body care tools technologies, and in particular, to an external cold-and-hot switching fascia gun.

### BACKGROUND

Fascia gun is a handheld device used to relax muscles and fascia. It transmits high-speed vibrations to deep muscle tissue to promote blood circulation and thereby relieving muscle tension and pain.

In order to meet the needs of different users, the massage head of the existing fascia gun can have two modes of cold/hot for users to choose from, and even functions such as temperature adjustment. In current technology, a toggle switch is usually integrated into the massage head, which means that the fascia gun must be stopped before the massage head can be operated. Although there is a conceptual wireless control method for temperature adjustment of the massage head, it still requires a controller to be carried, which is not convenient for the users to use and affects the user experience.

### SUMMARY

The purpose of the present disclosure is to provide an external cold-and-hot switching fascia gun to solve problems raised in the background technology.

To achieve the above objectives, the present disclosure provides the following technical solution.

An external cold-and-hot switching fascia gun, including a housing, the housing is provided with a driving device, a first controller, and a control panel that is provided on a surface of the housing; an output end of the driving device is rotatably connected to a piston component, the piston component is movably connected to the housing, one end of the piston component that is away from the driving device is detachably connected to a massage component; a second controller is provided in the massage component, and the second controller is connected to the cold-and-hot switching device inside the massage component;

the control panel is electrically connected to the first controller, and the first controller is matched with the second controller, so that the massage component is in a working state, and the cold-and-hot switching device is operated through the control panel.

In some embodiments of the present disclosure, the first controller and the second controller are wireless communication.

In some embodiments of the present disclosure, the massage component is provided with a power input terminal and a signal input terminal, the power input terminal and the signal input terminal are respectively electrically connected to the second controller;

the piston component is provided with a power output terminal that matches the power input terminal and a signal output terminal that matches the signal input terminal; the power output terminal and the signal output terminal are respectively electrically connected to the first controller.

In some embodiments of the present disclosure, a first coupler is provided at one end of the piston component that is away from the driving device, the first coupler is matched with a second coupler, and the second coupler is provided in the massage component;

the first coupler is provided with the power output terminal and the signal output terminal, and the second coupler is provided with the power input terminal and the signal input terminal.

In some embodiments of the present disclosure, one end of the piston component is provided with an opening corresponding to the first coupler, and the opening is configured for the second coupler to enter and connect with the first coupler;

the piston component is provided with a wiring channel, and a wiring hole is provided at one end of the piston component away from the first coupler; wiring of the first coupler passes through the wiring channel and exits from the wiring hole.

In some embodiments of the present disclosure, one end of the piston component is provided with a plug-in part, the massage component is provided with a plug-in position, an inner diameter of the plug-in position is larger than an outer diameter of the plug-in part, one side of the plug-in part is provided with a plurality of positioning blocks that are arranged in a circular array, and an inner wall of the plug-in position is provided with a plurality of clamp slots cooperating with the positioning blocks;

a silicone sleeve is provided on an outer periphery of the plug-in part, and the silicone sleeve is placed in the plug-in position along with the plug-in part, and the silicone sleeve is interference fit with the inner wall of the plug-in position.

In some embodiments of the present disclosure, a buffer table is provided around an outer side of the silicone sleeve, and the buffer table abuts against an outer edge of the plug-in position.

In some embodiments of the present disclosure, the massage component includes a shell, and a chamber independent of the plug-in position is provided in the shell configured to install the cold-and-hot switching device; the cold-and-hot switching device includes a cold-and-hot plate, one side of the cold-and-hot plate is in close contact with a contact surface of the shell, and the other side thereof is in contact with a heat dissipation block; a heat dissipation fan is provided on one side of the heat dissipation block, and a plurality of heat dissipation holes are provided on an outer periphery of the shell.

In some embodiments of the present disclosure, a fixed bracket is provided between the plug-in position and the chamber, and the bracket is configured to install the second coupler; a bottom of the second coupler is provided with a connecting circuit board, and the connecting circuit board is connected to the second controller; the second controller is connected to the heat dissipation fan and the cold-and-hot plate through wires.

In some embodiments of the present disclosure, the driving device includes a fixed seat that is horizontally arranged, an upper end surface of the fixed seat is provided with a motor, and a lower end surface of the fixed seat is provided with a flywheel, an output end of the motor is connected to the flywheel after passing through vertically the fixed seat, and the lower end surface of the flywheel is rotatably connected to a first bearing, the first bearing is rotatably connected to the swing arm, one end of the swing arm is rotatably connected to the piston component through a second bearing.

The beneficial effects of the present disclosure are as follows.

Regardless of a reciprocating motion of the piston component at the same speed, the first controller and the second controller continue to communicate. Of course, when the user wishes to change the current mode of the massage component, he only needs to select it in the control panel to switch the mode of the massage component without causing the fascia gun to stop working, thereby reducing waiting time, with fast switching speed, and it is more convenient than switching with a remote control.

Other features and advantages of the present disclosure will be described in detail in the following specific embodiments.

### BRIEF DESCRIPTION OF DRAWINGS

FIG. 1 is an overall structural diagram of the present disclosure.

FIG. 2 is a first structural diagram of a piston component and a massage component of the present disclosure.

FIG. 3 is a three-dimensional sectional view of the present disclosure.

FIG. 4 is a second structural diagram of the piston component and massage component of the present disclosure.

FIG. 5 is a structural diagram of a driving device of the present disclosure.

FIG. 6 is a structural diagram of the massage component of the present disclosure.

### NUMERAL REFERENCE

1 housing; 2 driving device; 21 fixed seat; 22 motor; 23 flywheel; 24 first bearing; 25 swing arm; 26 second bearing; 31 first controller; 32 control panel; 33 second controller; 341 first coupler; 342 power output terminal; 343 signal output terminal; 351 second coupler; 352 power input terminal; 353 signal input terminal; 4 piston component; 41 opening; 42 wiring channel; 43 wiring hole; 44 plug-in part; 45 positioning block; 46 silicone sleeve; 47 buffer table; 5 massage component; 51 shell; 52 cold-and-hot switching device; 521 cold-and-hot plate; 522 heat dissipation block; 523 heat dissipation fan; 524 heat dissipation hole; 531 plug-in position; 532 clamp slot; 54 bracket.

### DESCRIPTION OF EMBODIMENTS

Below, the technical solutions in the embodiments of the present disclosure will be clearly and completely described in combination with the accompanying drawings.

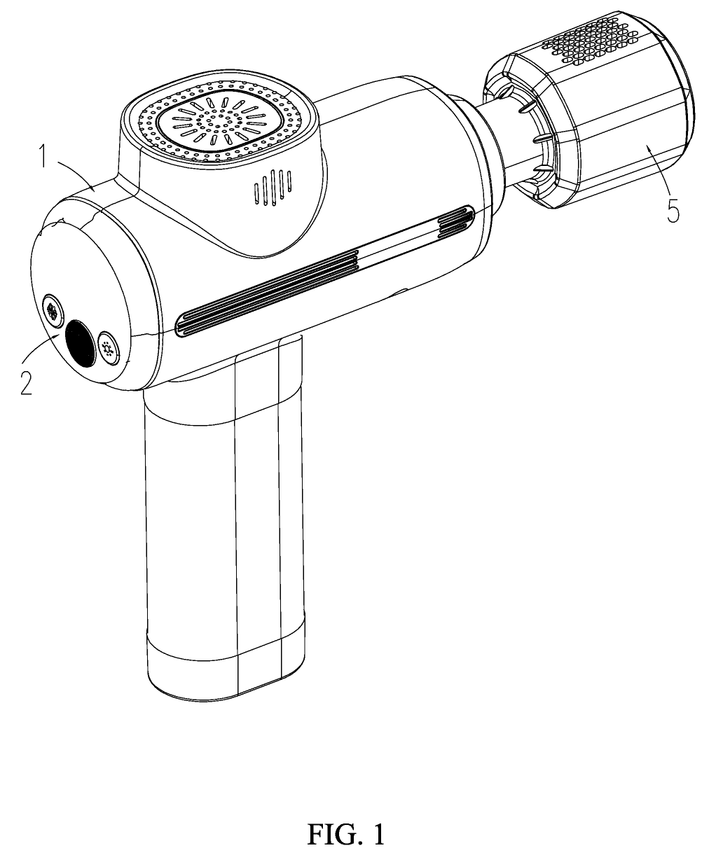

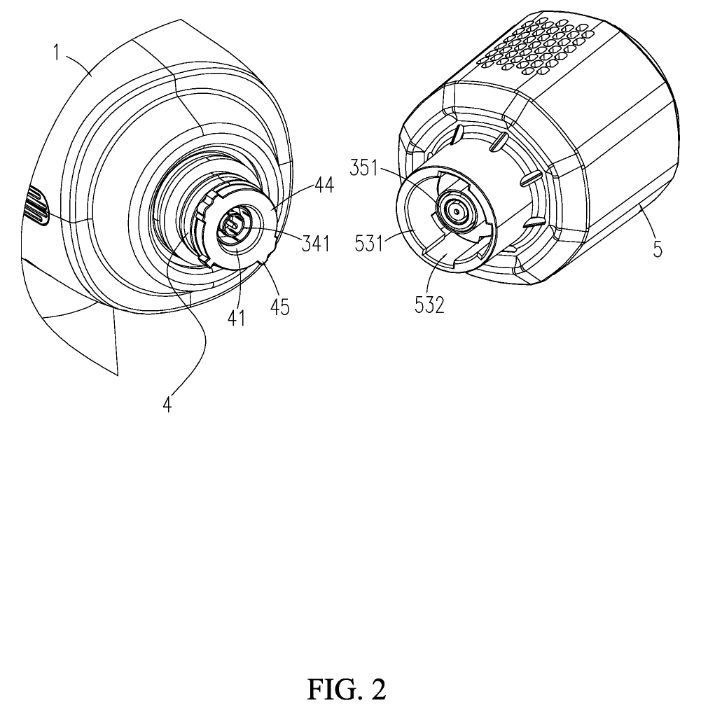

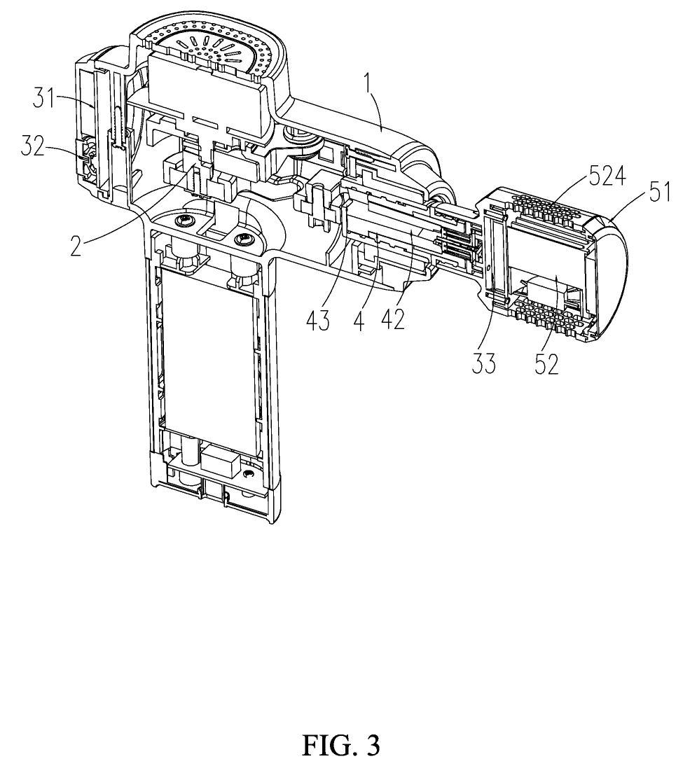

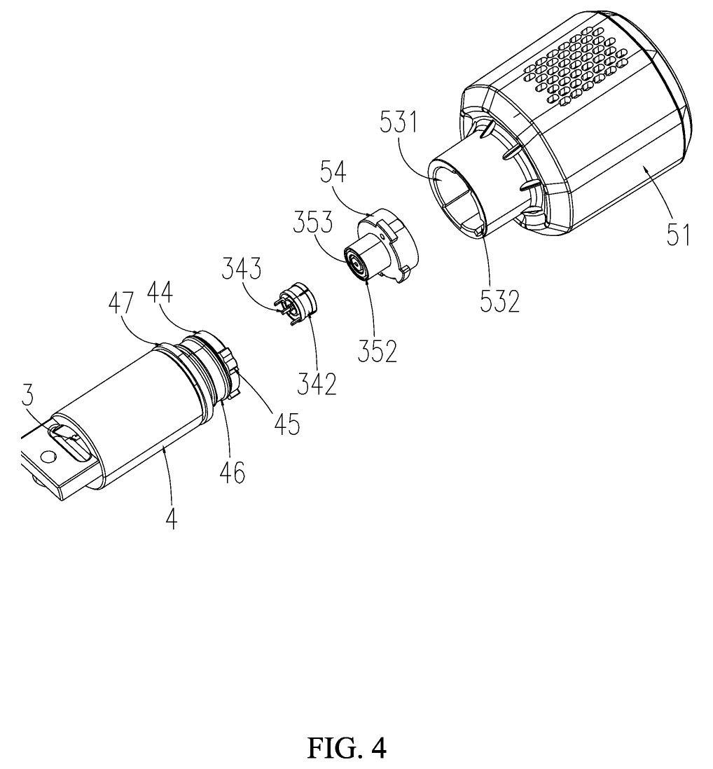

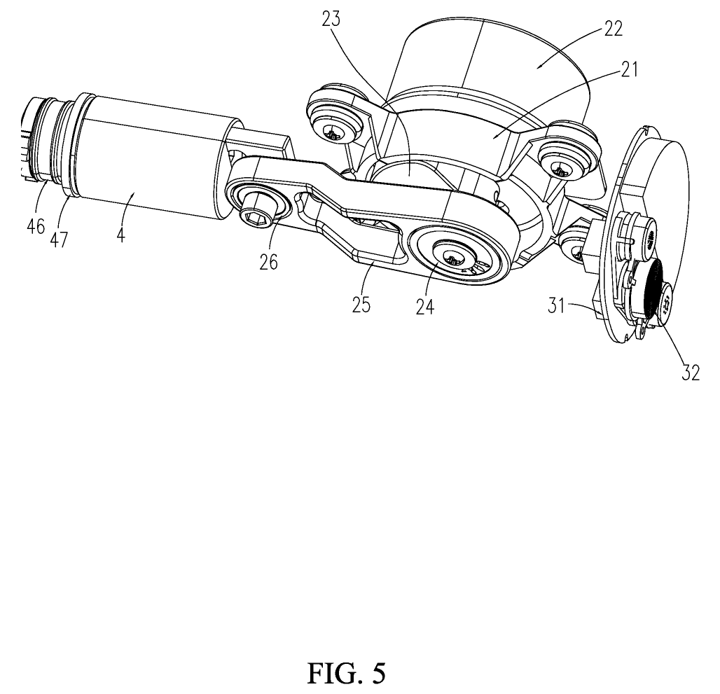

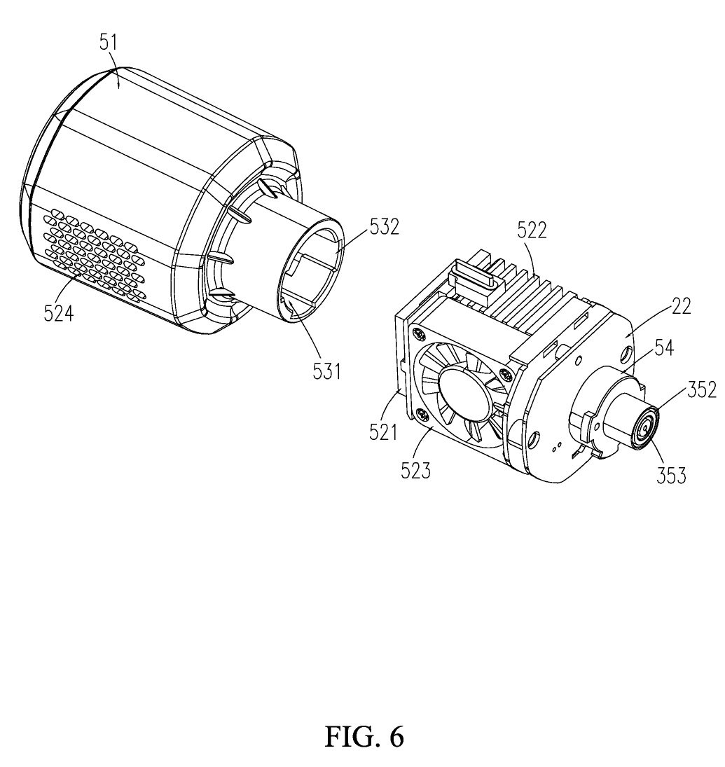

Please refer to FIGS. 1-6, a fascia gun described in the present disclosure directly controls a massage component 5 through a built-in module, rendering it easy for a user to operate a mode of the massage component 5. The fascia gun includes a housing 1, and the housing 1 is provided with a driving device 2, a first controller 31, and a control panel 32 that is provided on a surface of the housing 1, the housing 1 should include a handle for a user to grip and use. In an implementation mode, the control panel 32 is provided on one end face of the housing 1 that is far away from the piston component or on the handle for the user to control with one hand. In this embodiment, the power supply method is not limited, and in one embodiment, a battery can be built into the handle to provide power to the driving device 2 for wireless use, thereby providing the user with a better experience. An output end of the driving device 2 is rotatably connected to a piston component 4, and the piston component 4 is movably connected to the housing 1, one end of the piston component 4 that is away from the driving device 2 is detachably connected to the massage component 5. A second controller 33 is provided in the massage component 5, and the second controller 33 is connected to a cold-and-hot switching device 52 in the massage component 5. The control panel 32 is electrically connected to the first controller 31, and the first controller 31 is matched with the second controller 33.

In this embodiment, the power supply method for the massage component 5 is not limited. In the prior art, it can be achieved by providing a battery in the massage component 5, or by directly supplying power to it through the fascia gun body, etc., as long as it can work normally.

Before use, a suitable massage component 5 is selected and it is installed on the piston component 4, and the first controller 31 is communicated with the second controller 33. Then, the switch is activated to make the driving device 2 work, and the piston component 4 is driven to perform high-speed reciprocating motion relative to the housing 1. At the same time, the massage component 5 follows the motion and ultimately acts on the user’s skin. One surface of the massage component 5 in contact with the user’s skin can generate heat or cooling to achieve different massage effects. In the existing technology, it is already possible to achieve speed control of the driving device 2, thereby realizing the reciprocating speed of the piston component 4. The user can choose different modes of the driving device 2 according to different needs. For more convenient user use, buttons such as pneumatic switch, speed adjustment, and mode switching can be provided on the same control panel 32.

Regardless of the reciprocating motion of the piston component 4 at the same speed, the first controller 31 and the second controller 33 continue to communicate. Of course, when the user wishes to change the current mode of the massage component 5, he only needs to select it in the control panel 32 to switch the mode of the massage component 5 without causing the fascia gun to stop working, thereby reducing waiting time, having fast switching speed, and it is more convenient than switching with a remote control.

Assuming the remote control is a mobile phone with software installed for a controlling mode of the massage component 5, when user needs to switch modes, he needs to hold the fascia gun with one hand and use the other hand to operate the software on the mobile phone, which is very inconvenient. Therefore, more users will choose to turn off the fascia gun before operating the software on the mobile phone, which undoubtedly takes longer time, thereby highlighting the convenience of the structural setting in the present disclosure.

The present disclosure describes one communication method between the first controller 31 and the second controller 33 as follows.

In a first implementation mode, the first controller 31 and the second controller 33 adopt wireless communication. In implementation mode, a first Bluetooth module is provided in the first controller 31, a second Bluetooth module is provided in the second controller 33, and mode switching instructions should be integrated in the first controller 31. The first and second Bluetooth modules serve as a medium for transmitting data instructions.

Firstly, any one massage component 5 is selected and it is installed on the piston component 4. When powered on, the first Bluetooth module continuously emits matching signals. There is a pairing button provided on massage component 5 to trigger the second Bluetooth module. When the pairing button is pressed, the second Bluetooth module starts to complete wireless communication pairing. At this time, the massage component 5 can be controlled through the control panel 32. Besides that, an indicator light or a speaker can be provided on the massage component 5 to determine whether pairing is successful.

In an implementation mode, since the massage component 5 can be freely selected, in order to avoid incorrect pairing between the first controller 31 and the external massage component 5, the fascia gun can be used to supply power to the massage component 5. When the massage component 5 that is not connected to the fascia gun, it cannot be paired with the first controller 31 due to the lack of power.

In a second implementation mode: the massage component 5 is provided with a power input terminal 352 and a signal input terminal 353, the power input terminal 352 and the signal input terminal 353 are respectively electrically connected to the second controller 33. The piston component 4 is provided with a power output terminal 342 and a signal output terminal 343, the power output terminal 342 and the signal output terminal 343 are respectively electrically connected to the first controller 31. It should be noted that necessary modules such as power management module, control module, etc. should be provided in the first controller 31. If a battery is provided in the handle, the battery should be electrically connected to the first controller 31.

Firstly, any one massage component 5 is selected and it is installed on the piston component 4. At the same time, the power input terminal 352 and the signal input terminal 353 on the massage component 5 are connected to the power output terminal 342 and the signal output terminal 343 on the piston component 4, respectively. This connection method does not require matching and can be used directly, which is more convenient than the first implementation mode mentioned above.

Based on a further expansion explanation of the second implementation mode, one end of the piston component 4 that is away from the driving device 2 is provided with a first coupler 341. The first coupler 341 is matched with the second coupler 351, and the second coupler 351 is provided in the massage component 5. The first coupler 341 is provided with the power output terminal 342 and the signal output terminal 343, and the second coupler 351 is provided with the power input terminal 352 and the signal input terminal 353.

In an implementation mode, the first coupler 341 and the second coupler 351 are provided on a connection axis of the piston component 4 and the massage component 5, respectively, and the massage component 5 and the piston component 4 are installed in a plug-in manner. Therefore, while completing the installation, the first coupler 341 and the second coupler 351 are also connected to achieve transmission of electrical energy and signals.

Besides that, one end of the piston component 4 is provided with an opening 41 corresponding to the first coupler 341, and the opening 41 is configured for the second coupler 351 to enter and connect with the first coupler 341. The piston component 4 is provided with a wiring channel 42, and a wiring hole 43 is provided at one end of the piston component 4 away from the first coupler 341. Wiring of the first coupler 341 passes through the wiring channel 42 and exits from the wiring hole 43, and it is electrically connected to the first controller 31 after exited.

Below is an explanation of the connection method between the piston component 4 and the massage component 5.

One end of the piston component 4 is provided with a plug-in part 44, and the massage component 5 is provided with a plug-in position 531. An inner diameter of the plug-in position 531 is larger than an outer diameter of plug-in part 44. One side of the plug-in part 44 is provided with a plurality of positioning blocks 45 that are arranged in a circular array, and an inner wall of the plug-in position 531 is provided with a plurality of clamp slots 532 that cooperate with the positioning blocks 45. A silicone sleeve 46 is provided on an outer periphery of the plug-in part 44. In this embodiment, the clamp slots 532 are “L” shape and are extended to an edge of the plug-in position 531 to form a notch for the positioning blocks 45 to enter. When installation is required, the positioning blocks 45 align with the notch of the clamp slots 532, and then the plug-in part 44 is pushed into the plug-in position 531, so that the positioning blocks 45 enters bottoms of the clamp slots 532. At the same time, the silicone sleeve 46 is compressed and deformed to enter the plug-in position 531, and is located between the plug-in part 44 and the plug-in position 531, thereby filling a gap between the two to achieve interference fit connection. Finally, when the massage component 5 is rotated, the positioning blocks 45 horizontally enter another part of the clamp slots 532 to achieve clamping and fixation.

In an implementation mode, a buffer table 47 is provided around an outer side of the silicone sleeve 46, and the buffer table 47 abuts against an outer edge of the plug-in position 531.

It should be noted that due to a detachable installation between the massage component and the piston component, they are fastened after the connection is completed. Therefore, by using the piston component as an intermediate component, the massage component can obtain stable power supply. The built-in battery of the fascia gun is used for power supply. Therefore, when replacing the massage component, the fascia gun must be stopped before proceeding.

In the embodiment of the present disclosure, the massage component 5 includes a shell 51, and the shell 51 is provided with a chamber independent of the plug-in position 531 configured to install a cold-and-hot switching device 52. The main heating or cooling component in the cold hot device is a cold-and-hot plate 521, one surface of the cold-and-hot plate 521 is closely attached to a contact surface of the shell 51 to achieve heat exchange. During operation, a large amount of heat is generated and accumulated in the chamber, so it needs to be dissipated. The other side of the cold-and-hot plate 521 is in contact with the heat dissipation block 522, and a heat dissipation fan 523 is provided on one side of the heat dissipation block 522. A plurality of heat dissipation holes 524 are provided on an outer periphery of the shell 51, and gas exchange between the outside and the chamber is achieved through the heat dissipation fan 523, thereby achieving heat dissipation effect.

It should be noted that both the cold-and-hot plate 521 and the heat dissipation fan 523 are connected to the second controller 33.

In an implementation mode, a fixed bracket 54 is provided between the plug-in position 531 and the chamber, and the bracket 54 is configured to install the second coupler 351. A bottom of the second coupler 351 is provided with a connecting circuit board, and the connecting circuit board is connected to the second controller 33. The second controller 33 is connected to the heat dissipation fan 523 and the cold-and-hot plate 521 through wires.

In the embodiment of the present disclosure, the driving device 2 includes a fixed seat 21 that is horizontally arranged. An upper end surface of the fixed seat 21 is provided with a motor 22, and a lower end surface of the fixed seat 21 is provided with a flywheel 23. An output end of the motor 22 passes vertically through the fixed seat 21 and is connected to the flywheel 23. A lower end surface of the flywheel 23 is rotatably connected to a first bearing 24, and the first bearing 24 is rotatably connected to a swing arm 25. One end of the swing arm 25 is rotatably connected to the piston component 4 through a second bearing 26. The driving device 2 adopts a longitudinal distribution manner, which can reduce the space on both sides of the housing 1 and render the fascia gun more compact.

For those skilled in the art, it is apparent that the present disclosure is not limited to the details of the exemplary embodiments described above, and can be implemented in other specific forms without departing from the spirit or essential features of the present disclosure. Therefore, from any point of view, the embodiments should be regarded as exemplary and non-limiting, and the scope of the present disclosure is limited by the appended claims rather than the above description. Therefore, it is intended to encompass all variations falling within the meaning and scope of the equivalent elements of the claims within the scope of the present disclosure. Any reference numerals in the claims should not be regarded as limiting the claims involved.

Furthermore, it should be noted that although this specification is described according to the embodiments, not each embodiment only contains an independent technical solution. This description in the specification is only for clarity, and those skilled in the art should consider the specification as a whole. The technical solutions in each embodiment can also be appropriately combined to form other embodiments that those skilled in the art can understand.

What is claimed is:

1. An external cold-and-hot switching fascia gun, comprising a housing, the housing is provided with a driving device, a first controller, and a control panel that is provided on a surface of the housing;
an output end of the driving device is rotatably connected to a piston component, the piston component is movably connected to the housing,
one end of the piston component that is away from the driving device is detachably connected to a massage component;
a second controller is provided in the massage component, and the second controller is connected to the cold-and-hot switching device inside the massage component;
the control panel is electrically connected to the first controller, and the first controller is matched with the second controller, so that the massage component is in a working state, and the cold-and-hot switching device is operated through the control panel.

2. The external cold-and-hot switching fascia gun according to claim 1, wherein the first controller and the second controller are wireless communication.

3. The external cold-and-hot switching fascia gun according to claim 1, wherein the massage component is provided with a power input terminal and a signal input terminal,
the power input terminal and the signal input terminal are respectively electrically connected to the second controller;
the piston component is provided with a power output terminal that matches the power input terminal and a signal output terminal that matches the signal input terminal;
the power output terminal and the signal output terminal are respectively electrically connected to the first controller.

4. The external cold-and-hot switching fascia gun according to claim 3, wherein a first coupler is provided at one end of the piston component that is away from the driving device,
the first coupler is matched with a second coupler, and the second coupler is provided in the massage component;
the first coupler is provided with the power output terminal and the signal output terminal, and the second coupler is provided with the power input terminal and the signal input terminal.

5. The external cold-and-hot switching fascia gun according to claim 4, wherein one end of the piston component is provided with an opening corresponding to the first coupler, and the opening is configured for the second coupler to enter and connect with the first coupler;
the piston component is provided with a wiring channel, and a wiring hole is provided at one end of the piston component away from the first coupler;
wiring of the first coupler passes through the wiring channel and exits from the wiring hole.

6. The external cold-and-hot switching fascia gun according to claim 1, wherein one end of the piston component is provided with a plug-in part, the massage component is provided with a plug-in position,
an inner diameter of the plug-in position is larger than an outer diameter of the plug-in part,
one side of the plug-in part is provided with a plurality of positioning blocks that are arranged in a circular array, and an inner wall of the plug-in position is provided with a plurality of clamp slots cooperating with the positioning blocks;
a silicone sleeve is provided on an outer periphery of the plug-in part, and the silicone sleeve is placed in the plug-in position along with the plug-in part, and the silicone sleeve is interference fit with the inner wall of the plug-in position.

7. The external cold-and-hot switching fascia gun according to claim 6, wherein a buffer table is provided around an outer side of the silicone sleeve, and the buffer table abuts against an outer edge of the plug-in position.

8. The external cold-and-hot switching fascia gun according to claim 1, wherein the massage component comprises a shell, and a chamber independent of the plug-in position is provided in the shell configured to install the cold-and-hot switching device;
the cold-and-hot switching device comprises a cold-and-hot plate, one side of the cold-and-hot plate is in close contact with a contact surface of the shell, and the other side thereof is in contact with a heat dissipation block;
a heat dissipation fan is provided on one side of the heat dissipation block, and a plurality of heat dissipation holes are provided on an outer periphery of the shell.

9. The external cold-and-hot switching fascia gun according to claim 8, wherein a fixed bracket is provided between the plug-in position and the chamber, and the bracket is configured to install the second coupler;
a bottom of the second coupler is provided with a connecting circuit board, and the connecting circuit board is connected to the second controller;
the second controller is connected to the heat dissipation fan and the cold-and-hot plate through wires.

10. The external cold-and-hot switching fascia gun according to claim 1, wherein the driving device comprises a fixed seat that is horizontally arranged,
an upper end surface of the fixed seat is provided with a motor, and a lower end surface of the fixed seat is provided with a flywheel,
an output end of the motor is connected to the flywheel after passing through vertically the fixed seat, and the lower end surface of the flywheel is rotatably connected to a first bearing, the first bearing is rotatably connected to the swing arm,
one end of the swing arm is rotatably connected to the piston component through a second bearing.
